(19) United States
(12) Patent Application Publication
(10) Pub. No.: US 2012/0173335 A1
(43) Pub. Date: Jul. 5, 2012

(54) System and Methods for Enhancing Sales of Online Transactions

(76) Inventors: Meir Amzallag, Arad (IL); Tibor Madjar, Etobicoke (CA)

(21) Appl. No.: 12/981,439

(22) Filed: Dec. 29, 2010

(51) Int. Cl. G06Q 30/00

(52) U.S. Cl. 705/14.51

(57) ABSTRACT

Systems and methods for enhancing sales of online transactions is provided. In some embodiments, a buyer selects a primary purchase, which may be either a good or a service. The system receives the committed order for the primary purchase and acknowledges the order. Order acknowledgement includes verifying payment information of the buyer. Then, at least one complimentary purchase may be offered on a web-page to the user. The user may then choose whether to accept or decline the offer. If the offer for the complimentary purchase is accepted, then the order for the primary purchase can be combined with the accepted complimentary purchase. Alternatively, the orders for primary and complimentary purchases can be completed separately. Otherwise, if the offer for the complimentary purchase is rejected, then the order for the primary purchase is still completed. Thus, there is no risk through this cross-selling activity of any loss to the primary purchase.

### BACKGROUND

The present invention relates to a system and method for enhancing sales of online transactions. More specifically the invention relates to a system and method for providing transaction suggestions post payment collection in order to increase revenue generation via increased sales in online transactions.

The concept of up-selling and complimentary promotions (cross-sell) is well known. In an up-sell scenario, products, services or a higher cost item are presented to a prospective buyer. An example of up-sell would include offering the platinum version of an item when the buyer is looking at the basic version. Complimentary promotions typically include presenting the buyer with related items to those being purchased in order to attempt to increase the total items being purchased. An excellent example of complimentary promotions is the display of items viewed by other customers who purchased the item of interest on websites such as Amazon.com®, or providing an offer for a protection plan for an item being purchased.

While such cross-selling promotional activities often do result in higher priced transactions, it is also possible that the transaction may be cancelled by the buyer because the total “shopping cart” cost rapidly inflates to beyond what the purchaser originally thought they would be purchasing. A common phenomena is that such promotional activities will succeed in causing the prospective buyer to add more products to her cart than she would have otherwise; however at checkout the buyer becomes regretful of the added items and the reflectively higher shopping cart total. At this point the buyer may remove many of the extra items, or may even cancel the purchase altogether. Such lost sales decrease the value of the promotional activity.

Hence there is a need for a system to provide a purchase promotion which avoids the psychological remorse common to other forms of online promotions. Such a system and method would enable a retailer to lock in a transaction prior to the promotion, thereby limiting the risk of a lost sale.

In view of the foregoing, systems and methods for increasing revenue, via increased sales, of online transactions are provided. Such a system and method enables a merchant to complete the collection of payment information prior to the promotional display, thereby gaining the benefits of purchase suggestion without the associated loss in sales.

### SUMMARY

The present invention discloses a system and method for increasing sales and profitability of online transactions. Such a system may be employed by online retailers to increase sales volumes and drive greater profitability for the business.

In some embodiments, a buyer selects a primary purchase, which may be either a good or a service. The system receives the order for the primary purchase and completes the order. In some embodiments, order completion includes receiving payment information from the buyer and acceptance of the initial transaction by the buyer. Order completion may also, in some embodiments, include verifying payment information of the buyer. Payment verification may include verifying with a payment processor or extension of credit after verification of credit worthiness. In some embodiments, payment verification may be performed after the selection of each item (primary purchase and each complimentary purchase). In some other embodiments, only two payment verifications may be performed: one after the primary purchase, and a second for all complimentary purchases. In alternate embodiments, the verification of payment may be delayed until the entire transaction is generated (i.e. for both the primary purchase and all complimentary purchases are selected).

After order completion of the primary purchase, at least one complimentary purchase may be offered on a web-page to the user. Identifying the complimentary purchase may be performed by querying a database relating the primary purchase to the complimentary purchases. These related complimentary purchases may then be prioritized by analysis of sales information. The user may then choose whether to accept or decline the offer.

If the offer for the at least one complimentary purchase is accepted, then the order for the primary purchase can be completed along with the accepted complimentary purchase. Alternatively, the orders for primary and complimentary purchases can be completed separately.

Otherwise, if the offer for the at least one complimentary purchase is rejected, then the order for the primary purchase is still completed. Thus, there is no risk through this cross-selling activity of any loss to the primary purchase.

The transactions, including order placement, may occur over a network. In some embodiments the network is a wide area network, such as an internet. The order may originate from another server.

Note that the various features of the embodiments described above may be practiced alone or in combination. These and other features of embodiments of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1C are example schematic diagrams of embodiments of a system for increasing sales in an online marketplace;

FIGS. 2A and 2B are example schematic diagrams of a computer system which forms some portion of the system for increasing sales in an online marketplace, in accordance with some embodiments;

FIG. 3A is a first logical flowchart for the process of increasing sales in an online marketplace, in accordance with some embodiments;

FIG. 3B is a second logical flowchart for the process of increasing sales in an online marketplace, in accordance with some embodiments;

FIG. 4 is a logical flowchart for the process of generating a purchase suggestion, in accordance with some embodiments;

FIG. 5 is an illustration of an example purchase suggestion display, in accordance with some embodiments; and

FIG. 6 is an illustration of an example user interface, in accordance with some embodiments.

In the drawings, like reference numerals are sometimes used to designate like structural elements. It should also be appreciated that the depictions in the figures are diagrammatic and not to scale.

### DETAILED DESCRIPTION

Embodiments of the present invention will be described in detail with reference to selected preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well-known process steps and/or structures have not been described in detail in order to not unnecessarily obscure the present invention. The features and advantages of the present invention may be better understood with reference to the drawings and discussions that follow.

Note that throughout this application a number of references will be made to products, items, services, goods, warranties, service plans and other merchandise available to the buyer. Collectively, these goods and services are referred to as “purchases” for sake of clarity. It is considered within the scope of the present embodiments that “purchase” may refer to anything that may be bartered for or transacted.

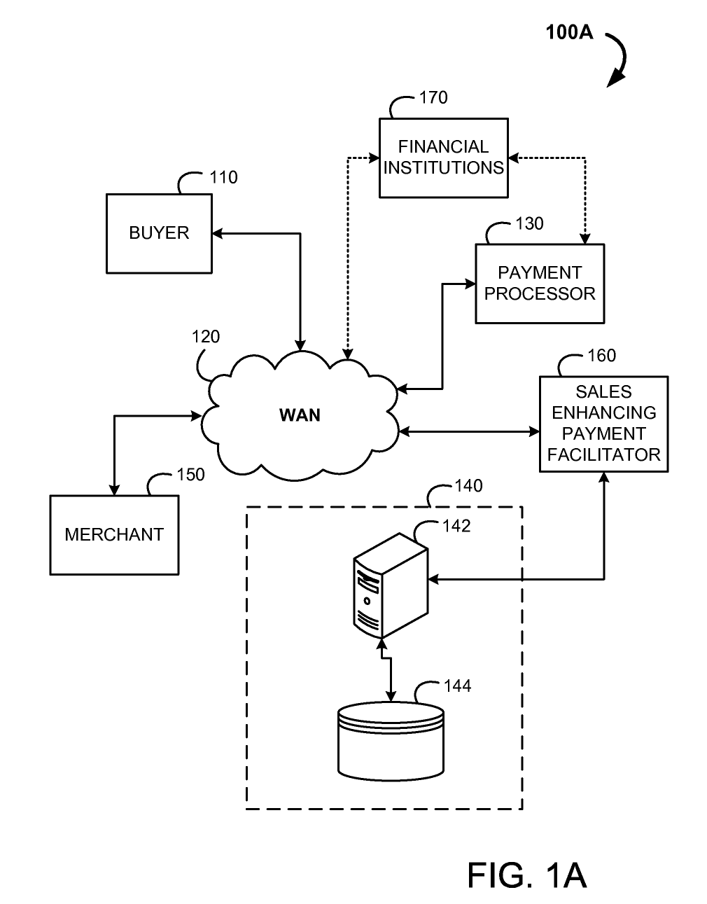

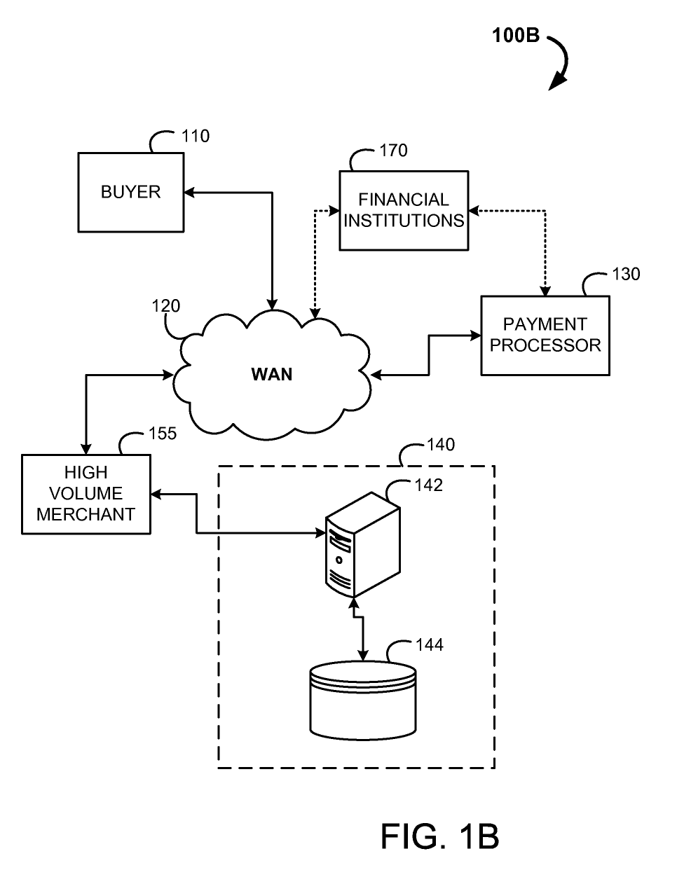

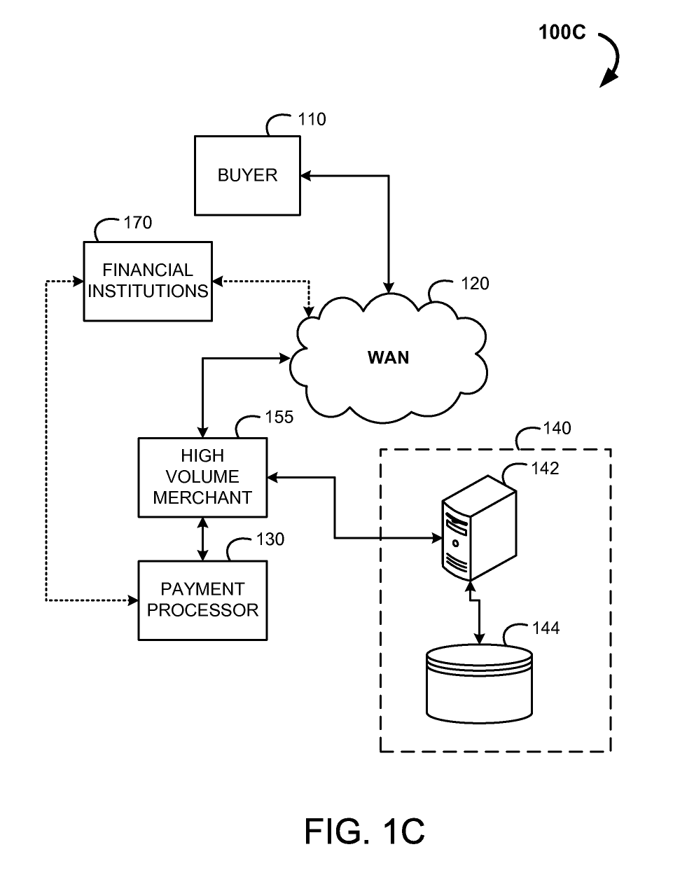

FIG. 1A is a first example schematic diagram of a system for increasing profitability and sales in an online marketplace through post order cross-selling, shown generally at 100A. A central Wide Area Network (WAN) 120 may connect one or more buyers 110 to a merchant 150.

The buyer 110 may be an individual, corporation, or other entity capable of buying a purchase. Typically, the buyer accesses a website of the merchant 150 and searches or browses for goods. Currently, online marketplaces exist for merchants that can range from the smaller specialty or custom goods stores to larger retailers such as Macys® and Home Depot®. The merchant's website enables the user to select purchases to buy, and add them to a “cart” for checkout.

Once the buyer has completed shopping, the merchant 150 may access a payment processor 130 in order to process the payment. The payment processor 130 serves as a gateway between the merchant 150 and financial institutions 170 in common embodiments. For small volume merchants 150, a sales enhancing payment facilitator 160 may be leveraged as a surrogate for the processing of payment data, in a secure manner, with the payment processor 130. The payment facilitator 160 may be an ecommerce company affiliated with the merchant in order to buy the purchase from the merchant 150 and resell to the buyer. An example of a payment facilitator 160 includes flash resellers such as PayPro Global®. Usage of a payment facilitator 160 is optional, as will be discussed later in reference to FIGS. 1B and 1C.

An example of a payment processor 130 includes gateways such as Chase Paymentech®. The payment processor 130 gateway may mediate the payment process between the financial institutions 170 (such as the buyer's bank and the merchant's bank), thereby relieving these merchants from the lengthy and security intensive processes involved in setting up and maintaining direct relationships with the banks Financial institutions 170 may include credit agencies such as Visa®, traditional banks, credit unions, and the like.

In some embodiments, such as those shown in FIG. 1A, the buyer 110 sends an order to the merchant 150. At checkout, the small volume merchant 150 may utilize a sales enhancing payment facilitator 160 for secure payment data collection. The payment facilitator 160 buys the purchase from the merchant and then transparently resells to the buyer 110. The payment facilitator 160 utilizes the payment processor 130 gateway in order to complete the transaction. The profit increasing payment facilitator 160 may request authorization from the buyer's bank (one of the financial institutions 170) via the payment processor 130. The payment processor 130 and financial institutions 170 may be communicate through the WAN 120, or may be coupled to one another via a modem line or other direct secure communication channel. The buyer's bank financial institution 170 supplies authorization back to the merchant 150. The buyer's bank (which may include a card issuing bank) then debits the funds from the card holder and reserves it for purchase. At this stage, the order is authorized and pending but not settled. In some embodiments, a separate request is sent to settle the order (typically after review of the order) whereby the funds are transferred from the buyer's bank financial institution 170 to the merchant's bank financial institution 170 (indirectly through the payment processor 130). Likewise, transaction may be cancelled resulting in a credit of funds to the buyer's account.

In FIGS. 1B and 1C the merchant 155 is a high volume retailer and therefore is equipped for collection of payment data using a secure site. Many major retailer websites are setup in this manner. Thus, the high volume merchant 155 may request authorization using the payment processor 130 to the financial institutions 170 without the need for a separate payment facilitator.

In the embodiments illustrated in FIG. 1A, the profit increasing payment facilitator 160 is coupled to a complimentary sales generator 140. The WAN 120 may be the internet, in some embodiments, or may comprise some other local or corporate network.

The complimentary sales generator 140 may include a server 142 for generating offers of related purchases and processing transactions. The server is coupled to a purchase database 144 which includes data on past purchase behavior of buyers, relation information between purchase goods and services, and possibly attribute data for any given purchase (such as pricing data).

While many online retailers specialize in the sale of physical goods rather than services, as online transactions become more prevalent, more merchant websites are offering warranties, service plans, delivery and other services. Thus, as noted above, the term purchase may include all sellable goods and/or services. It is also contemplated that goods also include less tangible products such as downloadable computer software, downloadable movies, downloadable reading material and downloadable video games.

Currently, many merchant websites provide additional purchase selections to the buyer during shopping as a means to generate additional revenue. For example, Amazon.com® routinely displays what other buyers also looked at when browsing their merchandise. Another common promotional tactic is to display a “pop-up” web browser window with a related item to the one being viewed by the buyer. Such promotions are occasionally helpful in increasing sales and profitability; however, they also tend to raise the dollar amount at checkout to an uncomfortable level for many buyers. This may lead to the buyer reconsidering the transaction and may lead to a loss of some sales.

In order to minimize these losses of sales, and yet maintain the benefits of purchase promotions, a system and method are presented where the complimentary sales generator 140 displays one or more purchase suggestions, via the payment facilitator 160, to the buyer 110 after the confirmation of payment on the primary purchase is completed. The server 142 of the complimentary sales generator may rely upon the data in the purchase database 144 in order to generate the purchase suggestions. The purchase suggestions may include the display of the purchase suggestion on a web-page with, or after, the confirmation of payment by the payment facilitator. In some embodiments, the purchase suggestion may include a pop-up web-page. Additionally, more than one purchase suggestion may be presented to the buyer.

Processing of payment transactions may be done in aggregate after all purchase selections have been made, may be performed as individual transactions, or may be performed after the primary purchase and after all complimentary purchases in aggregate. Transaction processing may depend upon merchant preference, and relationship between the merchant and payment processor 130.

FIG. 1B is a second example schematic diagram of a system for increasing profitability and sales in an online marketplace through post purchase cross-selling, shown generally at 100B. In this example embodiment, the merchant may be a higher volume merchant 155. Classic examples of online high volume merchants include Amazon.com® and eBay®. As a high volume merchant 155, it has the ability to deal directly in a secure manner with the third party payment processor 130 (such as Chase Paymentech®), therefore eliminating the need for payment facilitator 160 payment facilitator to handle secure collection of payment information. The payment processor 130 communicates with the financial institutions 170 through the WAN 120, or direct secure channel, in order to request and receive payment authorization, and eventually to settle the purchase.

In this embodiment, the high volume merchant 155 may be coupled directly to complimentary sales generator 140 for generation of complimentary purchase offers after finalization of the primary purchase.

In this embodiment, the central Wide Area Network (WAN) 120 may connect one or more buyers 110 to the high volume merchant 155. The WAN 120 may be the internet, in some embodiments, or may comprise some other local or corporate network. Again, the buyer 110 may be an individual, corporation, or other entity capable of buying a purchase. Typically, the buyer accesses a website of the high volume merchant 155 and searches or browses for goods.

As with the previous embodiment, the complimentary sales generator 140 may include a server 142 for generating offers of related purchases and processing transactions. The server is coupled to a purchase database 144 which includes data on past purchase behavior of buyers, relation information between purchase goods and services, and possibly attribute data for any given purchase (such as pricing data).

FIG. 1C is a third example schematic diagram of a system for increasing profitability and sales in an online marketplace through post order cross-selling, shown generally at 100C. In this example embodiment, the merchant may again be a high volume merchant 155. Further, unlike the previous examples, the payment processor 130 is directly affiliated with the high volume merchant 155. This is the situation with particular merchants which have their own financial services departments and/or divisions. For example eBay° owns PayPal® and as such the retailer is directly coupled to the payment processor 130. Likewise, some large merchants may have their own consumer credit cards or the like. In these circumstances, the payment processor 130 associated with the large volume merchant 155 may directly access the financial institutions 170 in order to authorize and settle the payment.

In such embodiments, the high volume merchant 155 may also be coupled directly to complimentary sales generator 140 for generation of complimentary purchase offers after finalization of the primary purchase.

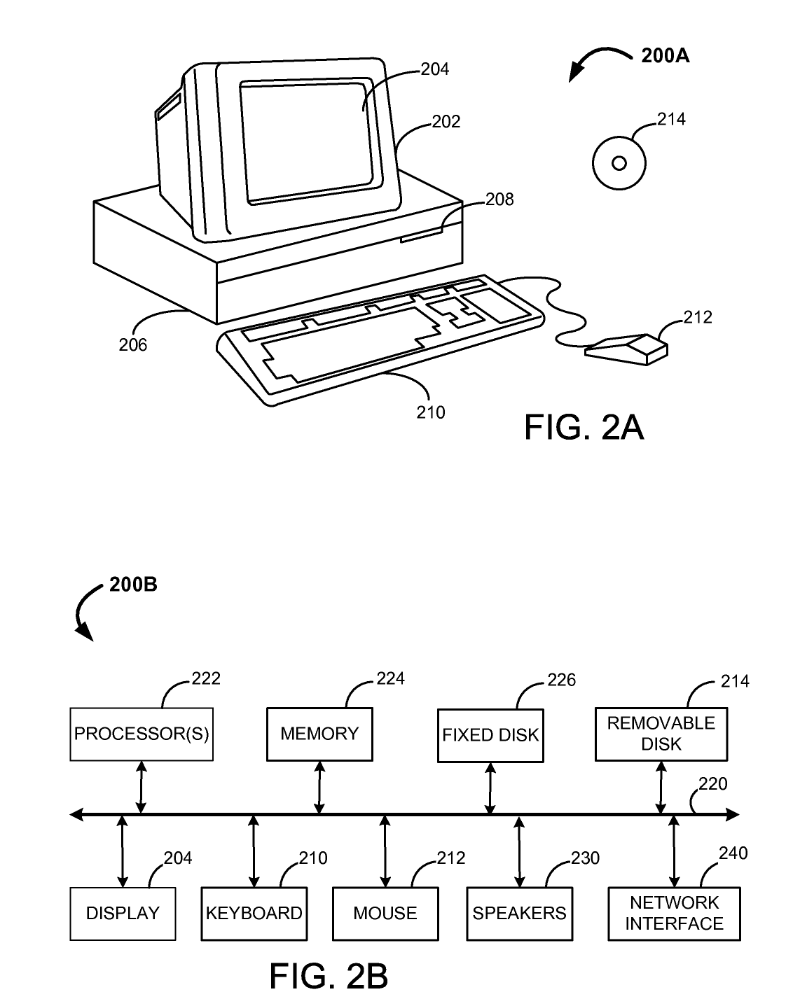

FIGS. 2A and 2B are example schematic diagrams of a computer system 200 which forms some portion of the system for increasing profitability and sales in an online marketplace, in accordance with some embodiments. FIG. 2A shows one possible physical form of the computer system. Of course, the computer system may have many physical forms ranging from an integrated circuit, a printed circuit board, and a small handheld device up to a huge super computer. Computer system 200 includes a monitor 202, a display 204, a housing 206, a disk drive 208, a keyboard 210, and a mouse 212. Disk 214 is a computer-readable medium used to transfer data to and from computer system 200.

FIG. 2B is an example of a block diagram for computer system 200. Attached to system bus 220 are a wide variety of subsystems. Processor(s) 222 (also referred to as central processing units, or CPUs) are coupled to storage devices, including memory 224. Memory 224 includes random access memory (RAM) and read-only memory (ROM). As is well known in the art, ROM acts to transfer data and instructions uni-directionally to the CPU, and RAM is used typically to transfer data and instructions in a bi-directional manner. Both of these types of memories may include any suitable of the computer-readable media described below. A fixed disk 226 is also coupled bi-directionally to CPU 222; it provides additional data storage capacity and may also include any of the computer-readable media described below. Fixed disk 226 may be used to store programs, data, and the like and is typically a secondary storage medium (such as a hard disk) that is slower than primary storage. It will be appreciated that the information retained within fixed disk 226 may, in appropriate cases, be incorporated in standard fashion as virtual memory in memory 224. Removable disk 214 may take the form of any of the computer-readable media described below.

CPU 222 is also coupled to a variety of input/output devices, such as display 204, keyboard 210, mouse 212 and speakers 230. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 222 optionally may be coupled to another computer or telecommunications network using network interface 240. With such a network interface, it is contemplated that the CPU might receive information from the network, or might output information to the network in the course of performing the above-described method steps. Furthermore, method embodiments of the present invention may execute solely upon CPU 222 or may execute over a network such as the Internet in conjunction with a remote CPU that shares a portion of the processing.

In addition, embodiments further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

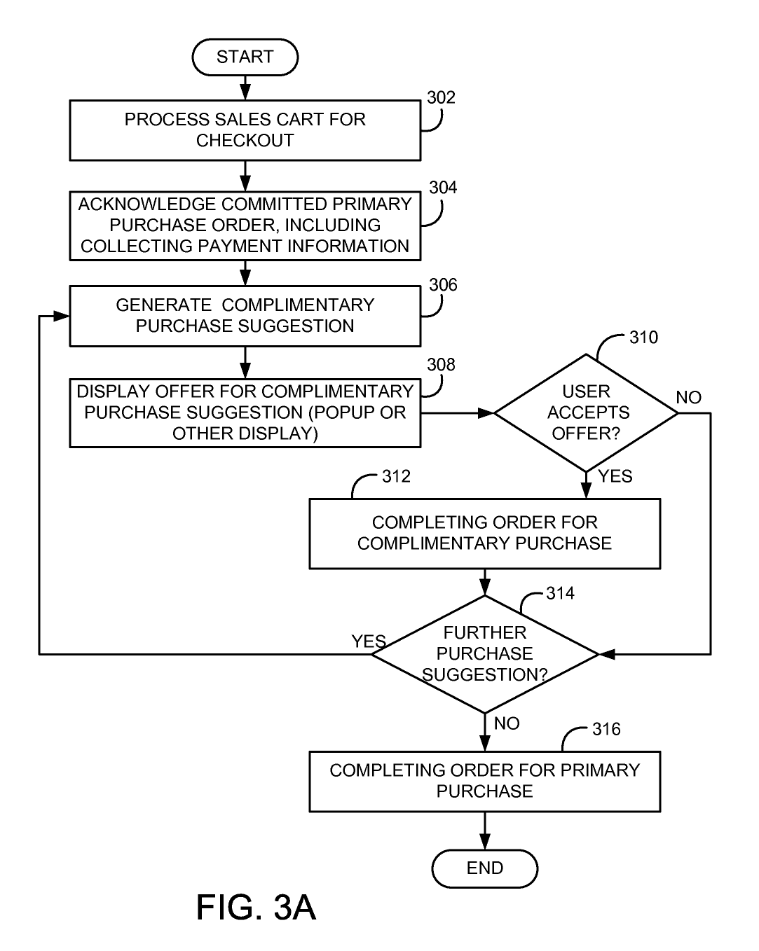

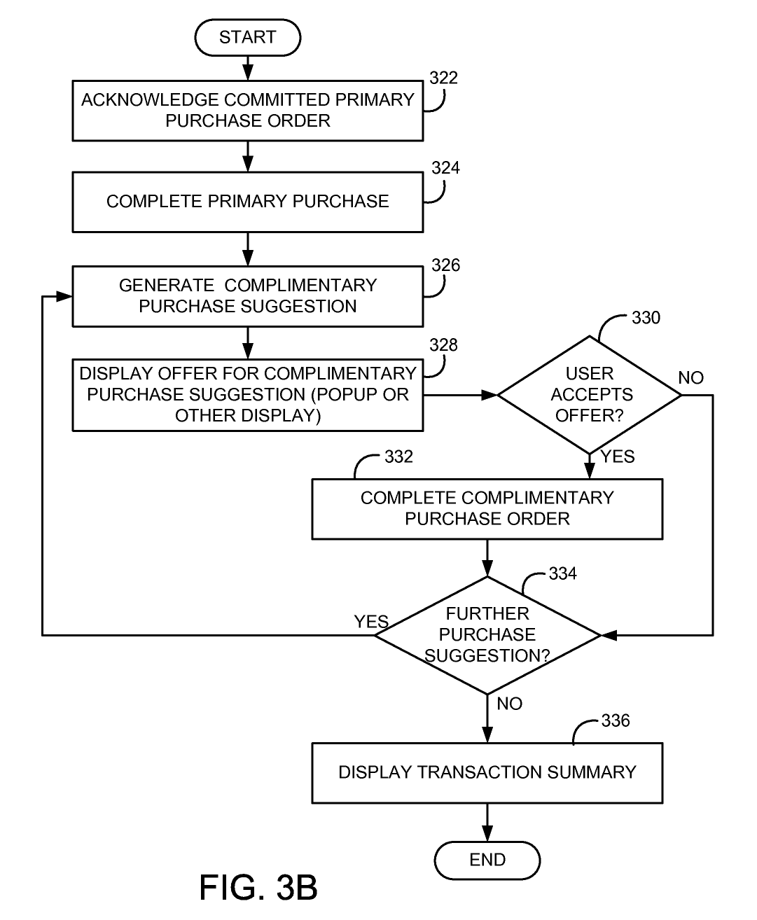

FIG. 3A is a first logical flowchart for the process of increasing profitability and sales in an online marketplace. In this example process the buyer accesses the merchant's website and makes selections for purchases. Traditional promotions, including purchase suggestions, may be employed at this stage in order to incentivize larger transactions. These purchases are added to the “cart” for checkout in most cases. These purchases may be referred to as the primary purchase for the buyer. Once the buyer 110 is done shopping they select the checkout option on the merchant's website in order to pay for and finalize the transaction. At checkout, the sale of the primary purchase is processed (at 302) by collecting delivery information and contact information from the buyer 110, and allowing for any last minute changes to the transaction. This may be referred to as a committed order, as the buyer 110 has supplied all information required to complete the sales transaction and has provided authorization to do so.

Upon commitment of the sale of the primary purchase, the payment information is collected from the buyer 110 and the primary purchase sale is acknowledged (at 304). Payment may include receiving electronic check information, account information (such as PayPal®), credit card information, or the extension of credit to the buyer. When credit is extended to the buyer, there is typically an approval process required where credit worthiness is determined.

After payment information is collected and the sales transaction for the primary purchase is complete, the buyer cannot reconsider the transaction. Only then (after sale transaction is committed) is a purchase suggestion generated for the buyer 110 (at 306). Generally, purchase suggestions relate the primary purchase to complimentary goods and services. For example, when the primary purchase is an appliance the purchase suggestion may include an extended warranty. When the primary purchase is clothing, the suggestion may include earrings or a similar accessory. Details of purchase suggestion generation will be discussed in greater detail below.

After generation of the purchase suggestion, the system may display it to the buyer 110 (at 308) as an offer for complimentary purchase. Display of the purchase offer may include presentation on the payment confirmation page, pop-up web-page, or similar on-line display tactic. The complimentary purchase offer may be displayed with selections to accept the additional purchase or decline the purchase. The buyer 110 may then make a selection whether to accept or decline the added purchase (at 310). If the buyer 110 chooses to buy the complimentary purchase, it may be added to the transaction by completing the complimentary purchase order (at 312). Order completion may include debiting the buyer's account of funds, extending credit to the buyer, charging a credit card account of the buyer, and starting processing the purchase for delivery to the buyer 110. Then a determination is made whether further purchase suggestions are to be displayed (at 314). Similarly, if the buyer were to decline the additional purchase (at 310), the system may directly proceed to determining if a further suggestion is to be displayed (at 314).

The decision whether or not to provide the buyer 110 with additional purchase suggestions may be based upon a total number of suggestions presented, or based upon the buyers decisions. For example, in some embodiments, a set number of suggestions will be displayed to each buyer. For this example, assume this set number is two. Thus, regardless of whether the buyer 110 selects or declines the additional purchases, a total of two pop-up windows with additional purchase offering will be displayed. In some alternate embodiments, the number of suggestions may be based upon the user input. For example, once a user declines a suggested purchase, then no others are provided. Since pop-up windows are merely one exemplary method for presenting suggestions to buyer 110, many other presentation methods known to one skilled in the computer arts are also possible.

If further purchase selections are to be displayed (at 314), based upon any of the disclosed or other known methods, the process may return to generating a purchase selection (at 306). Otherwise, if there are no further suggestions desired, then the transaction may be processed by completing the primary purchase order (at 316). Processing the transaction typically includes working with the payment processor 130 to charge the accurate amount to the buyer. For efficiency, all purchases made by the buyer 110 are processed for payment at one time, even though the payment information was collected prior to the selection of additional purchases. Such a system minimizes the required transactions with the payment processor 130, thereby reducing overall transaction fees typically charged by the payment processor 130 and/or financial institutions 170. Further, on the buyer's bill the transaction only appears once for all items or services bought. The process then ends.

FIG. 3B is a second logical flowchart for the process of increasing profitability and sales in an online marketplace, in accordance with some embodiments. This process differs from that of FIG. 3A in that each additional purchase is processed as an entirely new transaction. This reduces the amount on the buyer's monthly bill for any one transaction, which may have a positive psychological impact on the buyer. Further, in the case of power failure or other unexpected disruption, each transaction is self contained, thereby limiting the potential for lost sales. Processing transactions in this form may also be particularly helpful where the merchandiser is actually a marketplace for a number of different retailers. For example, eBay® itself provides very few services or goods. Rather, other retailers and individual sellers utilize eBay® to sell goods at a common website. Here it may be advantageous that each transaction is processed independently rather than shared given that multiple sellers may be involved. Further, when the payment processor 130 is affiliated with the merchant (as PayPal® and eBay® are), there is little concern that the additional transactions will result in onerous payment processor fees.

In this example process, the buyer 110 shops and generates a cart for checkout. The committed primary purchase order is acknowledged, which may include processing for shipping and collection of buyer information (at 322) as previously disclosed. The first transaction for the primary purchase is then completed (at 324) using collected payment information. This information may be temporarily stored for subsequent transactions. Again completion of an order may include debiting an account, extending credit, charging a credit card, etc.

Then, a complimentary purchase suggestion is generated (at 326), as discussed above. The complimentary purchase offer is presented to the buyer (at 328) via web-page, pop-up web-page, or the like. The buyer 110 then chooses whether to select the additional purchase or decline it (at 330). If the buyer 110 selects the additional purchase, then the additional purchase is completed as a separate transaction (at 332). This separate transaction may require the buyer 110 reentering some payment information, or may simply utilize the temporarily stored payment information. In some embodiments, temporarily stored payment information may be cleared after a set time period to reduce the risk of data theft.

After the additional transaction has been completed (at 332) or if the buyer 110 declines the additional purchase suggestion (at 330), then a decision is made whether to provide additional purchase selections (at 334). The methods of determining whether to make more suggestions may be based upon buyer behavior or a set number of promotional displays, as discussed previously. If further product suggestions are desired, the process may return to where a purchase suggestion is again generated (at 326). Otherwise, optionally a transaction summary may be displayed (at 336), and the process may end.

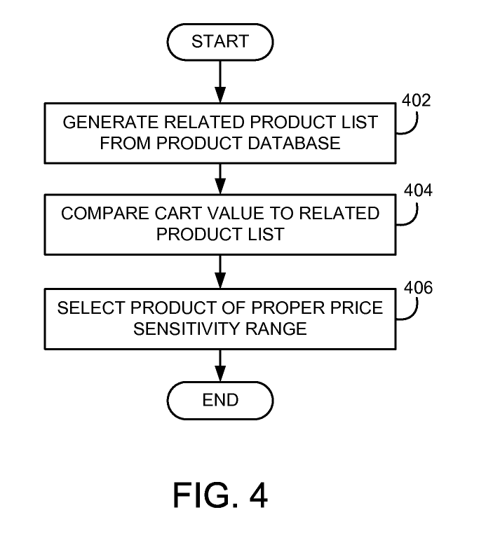

FIG. 4 is a logical flowchart for the process of generating a purchase suggestion, in accordance with some embodiments. In this example process the purchase database may be queried in order to generate a listing of related purchases to the primary purchase (at 402). This relation may be generated from past transactional history where items bought frequently together are grouped. Alternatively, logically related items (such as a DVD player and television) may be grouped. Based upon the primary purchase, the listing of logically related purchases may vary significantly. Additionally, generic items of low value may be added to the list of related purchases. For example, in many cases the suggestion of batteries may be unrelated to the primary purchase item, and yet appeals to many buyers since batteries are considered a needed consumable.

The cart value may then be compared against the listing of related purchases (at 404) in order to remove suggestion which are either too expensive or not expensive enough. For example, if the buyer is purchasing a suit for $500, a purchase suggestion of cufflinks at $100 (20% of cart value) would be acceptable. In comparison, if the primary purchase is a single dress shirt for $50, the suggestion of a cufflink set for $100 (200% of primary purchase value) would be unadvisable as the buyer will readily dismiss the suggestion. On the flip side, items too low in price may not be dismissed by the buyer, but provide little additional revenue. Thus, a range of price as related to the total cart value, or individual items in the cart, may be desirable.

Lastly, the additional purchase may be selected for suggestion (at 406) based upon relatedness to the primary purchase and pricing ranges. Other considerations which may affect generation of purchase suggestions may include manufacturer agreements, overstock of a particular good, volume discounts and the like. Also, note that the generation of purchase suggestions is generally well known for promotional activity during the shopping experience before collection of payment information. Any of these known methods of generating purchase suggestions may be readily employed in the present embodiment.

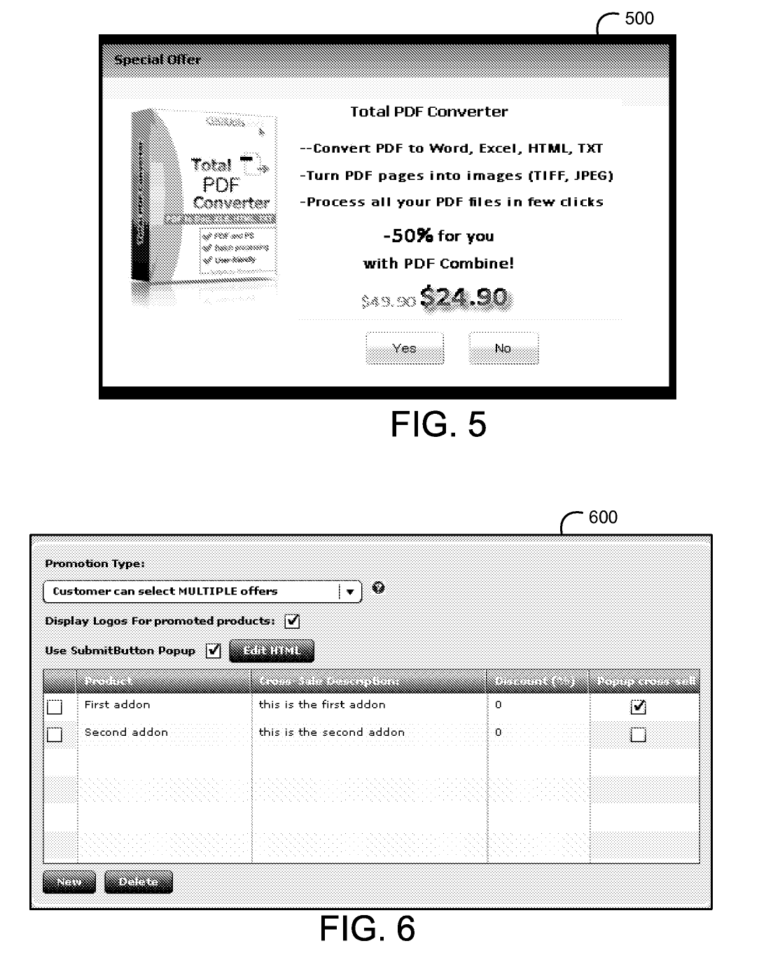

FIG. 5 is an illustration of an example purchase suggestion display 500, in accordance with some embodiments. In this example, the buyer 110 shopped for PDF Combine as a primary purchase. PDF Combine is PDF manipulation software for merging and splitting apart PDF files. After input of payment information and thereby locking in the primary purchase, the system generates a purchase suggestion for different PDF manipulation software: ‘Total PDF Converter’. The pop-up display 500 is generated illustrating the new purchase suggestion. The pop-up display may include graphics, product highlights, promotions and a price. Further, the display includes a means to select or decline the offer.

FIG. 6 is an illustration of an example user interface 600, in accordance with some embodiments. This user interface 600 enables the merchant 150 to configure the number, timing and format of the purchase suggestions. Different promotional types may be selected, and logo displays are configurable. In this example the pop-up is generated once the “submit” button is selected by the buyer finalizing the transaction for the primary purchase. Products can be designated and discounts applied. Further, the HTML code for the pop-up add may be further edited, in some embodiments. An example of the editable coding is presented below:

<style>

h1 {background:none; margin:0;}
#popup_wrapper {margin-bottom:20px;}
#popup_wrapper div.logo {background: none;}
#popup_wrapper div.contentBlock{width:700px; padding: 20px;margin:0 auto;}
#popup_wrapper div.contentBlock div.copyright {padding-bottom:0px;}
#popup_wrapper .left_one {padding-right:10px; padding-top:10px; float: left;}

/* #popup_wrapper .right_one {float: left;}*/

#popup_wrapper .left_one img {max-width: 200px;}
#popup_wrapper .right_one p, #popup_wrapper .right_one div {text-align: center;

font-weight: bolder;}

#popup_wrapper .right_one p.pr_disc {color: red;}
#popup_wrapper .right_one .pr_price .old {color: #BFBFBF; font-size: 11pt;}
#popup_wrapper .right_one .pr_price .new {color: #36AF3B; font-size: 13pt;}
#ctlSubmitButton_TB_window_cust{background-

image:url(https://secure.payproglobal.com/f/3233/perpetuum/backgrou.gif);
background-repeat:repeat-x; background-position: 0 0;}
#popup_wrapper div.contentBlock{padding:10px 10px 0;}
.logo a img{border:none;}
</style>
<script type=“text/javascript”>

function style_load( ){

var str = $(“#popup_wrapper .left_one”).text( );
if(“<PRODUCT_IMAGE>” == “”)
{

$(“#popup_wrapper .left_one”).css({“display”: “none”});
$(“#popup_wrapper .right_one”).css({“width”: “100%”});

}
if(“<PRODUCT_OLD_PRICE>” == “<PRODUCT_NEW_PRICE>”)
{

$(“#popup_wrapper .right_one .pr_disc”).css({“display”: “none”});
$(“#popup_wrapper .right_one .pr_price .old”).css({“display”: “none”});

}

}

function fullscreen_load( ){

ob.style.top=“0px”;
ob.style.left=“0px”;
ob.style.border=“none”;
ob.style.margin=“0px”;
ob.style.height=“100%”;
ob.style.width = “100%”;

}
function startTimer( ){
}
</script>
<div id=“popup_wrapper” onload=“style_load( );”>

<div class=“mainBlock”>

<div class=“contentBlock”>

<div class=“logo”>

<a href=“http://www.perpetuumsoft.com”

id=“ct100_homeHyperLink”><img alt=“PerpetuumSoft Logo”
src=“https://secure.payproglobal.com/f/3233/perpetuum/newLogo0.png”></a>

</div>
<div class=“clearer”></div>
<div style=“text-align:center;display:none;”>

<h1>Special Offer</h1>

</div>
<div class=“left_one”>

<PRODUCT_IMAGE>

</div>
<div class=“right_one”>

<p class=“pr_title”

style=“margin:0;display:none;”><PRODUCT_TITLE></p>

<CENTER>
<img

src=“https://secure.payproglobal.com/f/3233/perpetuum/support_banner.png”>

</CENTER>

<div class=“pr_price” style=“margin:0 8px; padding: 0 0 15px 0;

background:#ffffff;”>

<span class=“old”><strike><PRODUCT_OLD_PRICE></strike></span>
<span class=“new”><PRODUCT_NEW_PRICE></span>

</div>

</div>
<div class=“clearer”></div>
<div class=“copyright”></div>

</div>
</div>

</div>
<div style=“clear:both;”></div>

In sum, systems and methods for potentially increasing profit by enhancing sales in an online marketplace through post purchase cross-selling are provided. While a number of specific examples have been provided to aid in the explanation of the present invention, it is intended that the given examples expand, rather than limit the scope of the invention. For example, while some embodiments of the invention are illustrated with cross-sell displays constituting pop-up web-pages, it is entirely within the scope of the invention for alternate displays to be utilized such as offers routed to a mobile device, displayed on subsequent confirmation screens and the like.

While this invention has been described in terms of several preferred embodiments, there are alterations, permutations, modifications and various substitute equivalents, which fall within the scope of this invention. It should also be noted that there are many alternative ways of implementing the methods and systems of the present invention. It is therefore intended that the following appended claims be interpreted as including all such alterations, permutations, modifications, and various substitute equivalents as fall within the true spirit and scope of the present invention.

What is claimed is:

1. A computerized method for increasing sales of at least one complimentary purchases related to a transaction of a primary purchase, the method comprising:
receiving a committed order for a primary purchase;
acknowledging the committed order for the primary purchase;
displaying an offer for at least one complimentary purchase; and
if the offer for the at least one complimentary purchase is accepted, then completing the order for the at least one accepted complimentary purchase and completing the order for the primary purchase;
else if the offer for the at least one complimentary purchase is rejected, then completing the order for the primary purchase.

2. The method of claim 1 wherein the order for the primary purchase is completed by a merchant and transmitted over a network.

3. The method of claim 1 wherein the order for the primary purchase is completed by a reseller and transmitted over a network.

4. The method of claim 2 wherein the network is a wide area network.

5. The method of claim 3 wherein the network is a wide area network.

6. The method of claim 1 further comprising identifying the at least one complimentary purchase from a database relating the primary purchase to the at least one complimentary purchase.

7. The method of claim 1 further comprising prioritizing the offering of the at least one complimentary purchases.

8. The method of claim 1 further comprising analyzing prior sales information related to the primary purchase and associated complimentary purchases.

9. The method of claim 1 wherein the acknowledging of the order for the primary purchase includes verifying payment information.

10. The method of claim 1 wherein the acknowledging of the order for the primary purchase includes verifying credit worthiness information.

11. The method of claim 1 wherein the purchase includes at least one of goods, services, software and hardware.

12. The method of claim 1 further comprising if the offer for the at least one complimentary purchase is accepted, then combining the order for the primary purchase with the order for the at least one accepted complimentary purchase.

13. A computerized sales enhancing payment facilitator comprising:
a sales enhancer configured to relate a plurality of primary purchases to a corresponding plurality of complimentary purchases; and
a computerized user interface configured to:
receive and acknowledge a committed order for a primary purchase;
display an offer for at least one complimentary purchase related to the primary purchase provided by the sale enhancer; and wherein
if the offer for the at least one complimentary purchase is accepted, then the sales enhancer completes the order for the at least one accepted complimentary purchase and also completes the order for the primary purchase;
else if the offer for the at least one complimentary purchase is rejected, then the sales enhancer completes the order for the primary purchase.

14. The sales enhancing payment facilitator of claim 13 wherein the order for the primary purchase is completed by a reseller and transmitted over a network.

15. The sales enhancing payment facilitator of claim 14 wherein the network is a wide area network.

16. The sales enhancing payment facilitator of claim 13 further comprising identifying the at least one complimentary purchase from a database relating the primary purchase to the at least one complimentary purchase.

17. The sales enhancing payment facilitator of claim 13 further comprising prioritizing the offering of the at least one complimentary purchases.

18. The sales enhancing payment facilitator of claim 13 further comprising analyzing prior sales information related to the primary purchase and associated complimentary purchases.

19. The sales enhancing payment facilitator of claim 13 wherein the acknowledging of the order for the primary purchase includes verifying payment information.

20. The sales enhancing payment facilitator of claim 13 wherein the acknowledging of the order for the primary purchase includes verifying credit worthiness information.

21. The sales enhancing payment facilitator of claim 13 wherein the purchase includes at least one of goods, services, software and hardware.

22. The sales enhancing payment facilitator of claim 13, further comprising if the offer for the at least one complimentary purchase is accepted, then combining the order for the primary purchase with the order for the at least one accepted complimentary purchase.
